(19) United States
(12) Patent Application Publication
(10) Pub. No.: US 2018/0341805 A1
(43) Pub. Date: Nov. 29, 2018

(54) Method and Apparatus for Generating Codebooks for Efficient Search

(71) Applicant: THOMSON Licensing, Issy- les- Moulineaux (FR)

(72) Inventors: Himalaya JAIN, Rennes (FR); Cagdas BILEN, Rennes (FR); Joaquin ZEPEDA SALVATIERRA, Mercer Island, WA (US); Patrick PEREZ, Rennes (FR)

(21) Appl. No.: 15/772,227

(22) PCT Filed: Nov. 4, 2016
(86) PCT No.: PCT/EP2016/076734

§ 371 Date: Apr. 30, 2018

(30) Foreign Application Priority Data
Nov. 6, 2015 (EP) 15306761.6

(51) Int. Cl. G06K 9/00; G06T 7/73; G06F 17/00

(52) U.S. Cl. CPC G06K 9/00268; G06F 17/00; G06T 7/73

(57) ABSTRACT

In a particular implementation, a codebook C can be used for quantizing a feature vector of a database image into a quantization index, and then a different codebook (B) can be used to approximate the feature vector based on the quantization index. The codebooks B and C can have different sizes. Before performing image search, a lookup table can be built offline to include distances between the feature vector for a query image and codevectors in codebook B to speed up the image search. Using triplet constraints wherein a first image and a second image are indicated as a matching pair and the first image and a third image as non-matching, the codebooks B and C can be trained for the task of image search. The present principles can be applied to regular vector quantization, product quantization, and residual quantization.

### TECHNICAL FIELD

The present embodiments generally relate to a method and an apparatus for image search, and more particularly, to a method and an apparatus for generating codebooks for approximate nearest neighbor search in an image database.

### BACKGROUND

Approximate nearest neighbor (ANN) search is widely used in computer vision tasks, such as in feature matching and image retrieval. Many ANN search approaches use a compact representation of the feature descriptors and provide efficient search over the compact representation. The compact representation is supposed to conserve the similarity between the features which is required for getting a good approximation of the nearest neighbor. Finding nearest neighbor has application in various fields, including, but not limited to, pattern recognition, computer vision, computational geometry, databases, recommendation systems, DNA sequencing, estimation of multivariate densities, clustering for visualization, interpretation and compression. For large-scale datasets, the exact nearest neighbor is not feasible. Hence, ANN search approaches can be employed for many of these tasks.

### SUMMARY

According to a general aspect, a method for performing image search is presented, comprising: accessing a first feature vector corresponding to a query image; encoding a second feature vector, corresponding to a second image of an image database, as an encoded vector using a first set of codebooks and a second set of codebooks, the first set of codebooks being different from the second set of codebooks, wherein the first set of codebooks is used to vector quantize the second feature vector into an index, and the second set of codebooks is used to approximate the second feature vector as the encoded vector based on the index, and determining a distance measure between the query image and the second image, based on the first feature vector and the encoded vector; and providing the second image as output based on the distance measure between the query image and the second image.

At least one of the query image and the first feature vector may be received from a user device via a communication network, the method for performing image search may further transmit a signal indicating the second image to the user device via the communication network.

The first set of codebooks and the second codebooks may be determined based on a set of triplet constraints, wherein each triplet constraint indicates that a first training image of the triplet is more similar to a second training image of the triplet than to a third training image of the triplet. The first set of codebooks and the second codebooks may be trained such that a distance measure determined for training images corresponding to a triplet constraint is consistent with what the triplet constraint indicates.

The distance measure may be determined based on one or more lookup tables. One of vector quantization, product quantization and residual quantization can be used. The second set of codebooks may be smaller than the first set of codebooks.

The first feature vector may be transformed, and the distance measure may be determined based on the transformed first feature vector and the encoded vector.

According to another general aspect, an apparatus for performing image search is presented, comprising: an input configured to access at least one of a query image and a first feature vector corresponding to the query image; and one or more processors configured to: encode a second feature vector corresponding to a second image of an image database, as an encoded vector using a first set of codebooks and a second set of codebooks, the first set of codebooks being different from the second set of codebooks, wherein the first set of codebooks is used to vector quantize the second feature vector into an index, and the second set of codebooks is used to approximate the second feature vector as the encoded vector based on the index, and determine a distance measure between the query image and the second image, based on the first feature vector and the encoded vector, and provide the second image as output based on the distance measure between the query image and the second image.

The first set of codebooks and the second codebooks may be determined based on a set of triplet constraints, wherein each triplet constraint indicates that a first training image of the triplet is more similar to a second training image of the triplet than to a third training image of the triplet. The first set of codebooks and the second codebooks may be trained such that a distance measure determined for training images corresponding to a triplet constraint is consistent with what the triplet constraint indicates.

The distance measure may be determined based on one or more lookup tables. One of vector quantization, product quantization and residual quantization can be used. The second set of codebooks may be smaller than the first set of codebooks.

The present embodiments also provide a non-transitory computer readable storage medium having stored thereon instructions for performing any of the methods described above.

### BRIEF DESCRIPTION OF THE DRAWINGS

FIG. 1 illustrates using two different codebooks for quantization and approximation using a simplified example, according to an embodiment of the present principles.

FIG. 2 illustrates interpretation of residual quantization as a deep network, according to an embodiment of the present principles.

FIG. 3 illustrates an exemplary training set, wherein q is a training query vector.

FIG. 4 illustrates an exemplary method for training the codebooks, according to an embodiment of the present principles.

FIG. 5 illustrates an exemplary method for performing image search, according to an embodiment of the present principles.

FIG. 6 illustrates an exemplary framework for performing image search, according to an embodiment of the present principles.

FIG. 7 illustrates an exemplary system that has multiple user devices connected to an image search engine according to the present principles.

FIG. 8 illustrates a block diagram of an exemplary system in which various aspects of the exemplary embodiments of the present principles may be implemented.

### DETAILED DESCRIPTION

A typical ANN search approach uses vector quantization methods to obtain a compact representation. This compact representation often enables a rapid approximation of a similarity or distance metric, mostly using Euclidean distance. Yet vector quantization is designed with the objective of minimizing the quantization error which is not optimized for the actual task of finding ANN. With this observation, we propose to adapt the quantization for the task of ANN search. In our formulation we use the Euclidean distance to compare vectors, but this can be modified to adapt to a different similarity or distance metric.

We assume we are given a large database of vectors [symbol] ={xᵢ∈ [symbol] ^{D}}ᵢ. Given a query vector y∈ [symbol] ^{D}, we wish to find the closest vectors from the database in a computationally efficient manner. A common path to do this consists of compressing the vectors xᵢ using a representation that, besides being compact, is also functional in that it enables efficient distance computations. Many of the more successful methods achieve this dual goal by using some variant of vector quantization.

In the following, we first formalize the ANN search problem, and subsequently present existing solutions based on Vector Quantization (VQ) and two extensions thereof, Product Quantization (PQ) and Residual Quantization (RQ). We then discuss K-means, a standard approach to learn codebooks, and why it is not well suited to the image search task.

Approximate Nearest Neighbor (ANN) Search

Given the database [symbol] and a query vector y, we wish to find the nearest neighbors of y from within [symbol] . For brevity, we focus on the Euclidean distance, but the approaches described herein are valid for other distance functions. Letting [symbol] ⊂{1, . . . , | [symbol] |} denote the identifiers of these nearest neighbors and

d(y,x)=∥y−x∥₂ (1)

the distance function, we have that IC should be such that

d(y,xⱼ)≤d(y,xᵢ), ∀j∈ [symbol] ,i∉ [symbol] . (2)

When working with large databases [symbol] ={xᵢ∈ [symbol] ^{D}}ᵢ of high-dimensional vectors, exhaustive search might be the only option if one is to obtain the true [symbol] due to the failure of partitioning methods in high-dimensional spaces. Yet the large complexity of exhaustive search in high-dimensional spaces and large-scale scenarios makes it intractable.

An alternative is to instead settle for an approximation [symbol] of the true nearest neighbors [symbol] , and this is referred to as Approximate Nearest Neighbor (ANN) search. Letting | [symbol] |=| [symbol] | for simplicity, a good approximation will be such that | [symbol] ∩ [symbol] |≃| [symbol] |. In this work we focus on ANN search methods that rely on an approximation of Eq. (1) that is cheaper to compute than Eq. (1), and in particular on approximations of Eq. (1) based on vector quantization and extensions thereof.

Vector Quantization

Given a codebook C=[cⱼ]ⱼ₌₁^{N}∈ [symbol] ^{D×N}, where [cⱼ]ⱼ₌₁^{N} denotes a matrix with columns cⱼ,j=1, . . . , N, vector quantization consists of representing a given vector x∈ [symbol] using one of the codevectors cⱼ or, equivalently, its identifier j∈{1, . . . , N}. In selecting a codevector, the aim is generally to choose the closest one under the Euclidean distance:

$$q ( x ; C ) {=}^{Δ} {argmin}_{j ∈ \{ 1 , … , N \}} {‖ x - {c}_{j} ‖}_{2} , \qquad ( 3 )$$

where q(x; C) is the index of a codevector corresponding to vector x in codebook C.

While the vector quantization method in Eq. (3) succeeds in finding the best codevector to represent x, it requires that ∥x−cⱼ∥₂ be computed exhaustively for all j=1, . . . , N, thus limiting the codebook size N if we are to expect reasonable complexities.

When computing distances between vectors y and all the xᵢ∈ [symbol] , vector quantization achieves efficiency by using the representation cⱼ_{ᵢ} of xᵢ, where

jᵢ=q(xᵢ;C). (4)

Rather than computing the exact distance ∥y−xᵢ∥₂ between y and all xᵢ, one can use

μⱼ_{ᵢ}(y)=∥y−cⱼ_{ᵢ}∥₂. (5)

This approximation can only take one of N possible values, and hence distances over large sets [symbol] can be computed efficiently by first building a lookup table of all possible distances

L(y,C)=[μ₁(y), . . . ,μ_{N}(y)], (6)

and then reading μⱼ_{ᵢ}(y) from position jᵢ of this lookup table. Hence, the compressed representation {jᵢ}ᵢ of [symbol] is all that needs to be stored, and this representation is further functional in that it can be used directly to look up distances from the lookup table. Note, however, that having a large number of codevectors is important if we are to have a high distance resolution, but the complexity associated with computing ∥x−cⱼ∥, j=1, . . . , N (required in Eqs. (3) and (6)) limits how large the codebook can be.

Product Quantization

Product Quantization (PQ) is an alternative quantization method that makes it possible to use very large codebooks, while keeping the complexity associated with computing ∥x−cⱼ∥, j=1, . . . , N low. PQ is based on partitioning the signal space [symbol] ^{D} into P subspaces of size d so that D=Pd. Accordingly, the signal vectors x∈ [symbol] ^{D} are partitioned into sub-vectors x^{l}∈ [symbol] ^{d}, l=1, . . . , P so that

x=[x^{1T}, . . . ,x^{PT}]^{T}. (7)

When vector quantizing x, each sub-vector is quantized separately using a different codebook Cₗ:

jₗ=q(x^{l};Cₗ), l=1, . . . ,P. (8)

The resulting quantization indices [j₁, . . . , j_{P}] are the compressed representation of vector x. This is equivalent to vector quantizing x directly in a codebook of size N=|C₁|· . . . ·|C_{P}| given by the Cartesian product C=C₁× . . . ×C_{P}.

Similar to the case of vector quantization, letting y=[y^{1T}, . . . y^{PT}]^{T} be the partition of y compatible with Eq. (7), distances

$${‖ y - x ‖}_{2}^{2} = {\sum }_{l = 1}^{P} {‖ {y}^{l} - {x}^{l} ‖}_{2}^{2}$$

can be approximated using

$${\sum }_{l = 1}^{P} {‖ {y}^{l} - {c}_{{j}_{l}}^{l} ‖}_{2}^{2} , \qquad ( 9 )$$

where cⱼ^{l} denotes codevector j of codebook Cₗ. The approximation in Eq. (9) can once again be computed efficiently by reading the l-th term in the summation from position jₗ of a previously-built lookup table L(y^{l},Cₗ).

Residual Quantization

The idea of residual quantization is to repetitively quantize the residual, or error, in the reconstruction of the vector and then add this quantized error to further improve the reconstruction. Residual quantization has layered structure, and each layer is a separate vector quantizer.

The residual at the output of layer l is, where l=1, . . . , P and, for convenience, r⁰ [symbol] x:

r^{l}=r^{l-1}−cⱼ_{ₗ}^{l}, (10)

jₗ=q(r^{l-1},Cₗ). (11)

The approximate distance is:

∥y−Σₗ₌₁^{P}cⱼ_{ₗ}^{l}∥₂²=y^{T}y+Σₗ₋₁^{P}Σₖ₌₁^{P}cⱼ_{ₖ}^{kT}cⱼ_{ₗ}^{l}=2Σₗ₌₁^{P}y^{T}cⱼ_{ₗ}^{l}. (12)

As the vector representation is given by the sum of a few codevectors, residual quantization also has practically a very large codebook. As in PQ, the quantization indices [jᵢ₁, . . . , j_{iP}] are the compressed representation of xᵢ.

The distance computation in Eq. (12) is done efficiently by building a lookup table for the inner product y^{T} cⱼ_{ₗ}^{l} and storing the norm of quantized xᵢ i.e., the second term in Eq. (12).

K-Means Codebooks

The above described vector quantization methods all rely on the base quantization expression in Eq. (3), as can be seen from Eqs. (4), (8) and (11) (for VQ, PQ and RQ, respectively). This base quantization expression in turn requires a codebook, and this is commonly learned using K-means.

Given a training set [symbol] ={zᵢ}ᵢ of data vectors zᵢ, a K-means codebook is given by

$$B ( 𝒵 ) = {argmin}_{C = \{ {c}_{1} , … , {c}_{N} \}} {\sum }_{i} {‖ {z}_{i} - {c}_{q ( x , C )} ‖}_{2}^{2} . \qquad ( 13 )$$

The above approach aims to minimize the representation error (i.e., the term inside the summation) of the data vectors in [symbol] ^{D}. This is indeed related to the approximate search task, as codebooks producing very good distance approximations Eqs. (5), (9) and (12) (for VQ, PQ and RQ, respectively) are bound to produce good approximate nearest neighbors.

Yet, given the particularities of ANN search applications, K-means learned codebooks may not be best suited to the ANN task. The first of these particularities is that real datasets have highly irregular distributions, even though it might be possible to show that K-means is optimal for some more regular distribution, like the normal distribution, for example when | [symbol] |=| [symbol] |. The second of these particularities is that many applications often require only a small number of the (approximate) nearest neighbors of a given query vector, i.e., | [symbol] |<<| [symbol] |. Together, these two observations suggest that the best codebook for the ANN task is not necessarily the one that best reconstructs the dataset, at least when using codebooks that are relatively small.

We hence propose an alternate formulation for codebook learning for the ANN task. In one embodiment, we use different codebooks for quantization and approximation, and we also propose techniques for learning the codebooks.

The main difficulty in deriving a codebook learning algorithm for an arbitrary objective function is that the quantization expression Eq. (3) is highly non-smooth and further has discontinuities at every point that is halfway between any two codevectors. This needs to be addressed if we are to embed the minimization function as Eq. (3) in a learning objective.

Differentiating Vector Quantization

To this end we make use of the one-hot vector representation of Eq. (3), which is a vector \hat{b}(x,C) with zeros everywhere except for a 1 at position q(x,C). Letting [symbol] · [symbol] denote the indicator function that equals 1 if the condition in the argument is true and 0 otherwise, the one-hot vector is given by

\hat{b}(x,C)=[ [symbol] i=q(x,C) [symbol] ]ᵢ. (14)

With this representation, we can write the approximation cⱼ,j=q(x,C), of vector x for the case of vector quantization using

\hat{Q}(x,C)=C\hat{b}(x,C). (15)

Our aim is to embed the above expression into a learning objective that we will minimize using a stochastic variant of gradient descent. We will hence calculate the gradient of the objective function, and this will in turn depend on the Jacobian matrix of \hat{Q}(x,C). This can in turn be obtained entirely form the Jacobians of \hat{Q} with respect to each codevector c in codebook C, which we denote as

$$\frac{\partial \hat{Q}}{\partial c} .$$

Note that we use the convention that the Jacobian of a vector v(θ) is the matrix

$$\frac{\partial v}{\partial θ}$$

with (i,j)-th entry

$$\frac{\partial {v}_{i}}{\partial {θ}_{j}} .$$

Sub-Gradient Approach

One possible approach to derive an adequate expression is to rely on sub-gradient methods, using

$$\frac{\partial \hat{Q}}{\partial {c}_{j}} = 〚 i = j 〛 I \qquad ( 16 )$$

as the Jacobian of Eq. (15), where i=q(x,C) and I is the identity matrix. This approach has the benefit that it does not suffer from problems related to numerical imprecision, yet it does suffer from problems related to the discontinuities of \hat{b}(x,C). Note that, in this case, Eq. (16) is not technically the Jacobian of Eq. (15), as Eq. (15) is not differentiable everywhere, but Eq. (16) is still relevant in the context of sub-gradient methods.

Relaxation Approach

A second possible approach to obtain a Jacobian expression of Eq. (14) is to relax the codevector assignment using a differentiable proxy. To this end, we make use of the soft-max operator to obtain the following differentiable approximation b^{α}(x,C) of \hat{b}(x,C)

$${b}^{α} ( x , C ) = {[ \frac{exp ( - α {‖ x - {c}_{i} ‖}_{2}^{2} )}{{Σ}_{j} exp ( - α {‖ x - {c}_{j} ‖}_{2}^{2} )} ]}_{i} , \qquad ( 17 )$$

and note that, with probability 1,

$${lim}_{α \to ∞} {b}^{α} ( x , C ) = \hat{b} ( x , C ) .$$

Indeed using larger α will result in better approximations by b^{α} of \hat{b}, but likewise in greater difficulties related to numerical imprecision. Hence a good approach might be to start a learning procedure with low a and increase it at an empirically chosen schedule. Other soft-max operators can also be used.

Hence, when using this relaxation method to approximate \hat{b}, we will (i) use the approximation Eq. (17) of Eq. (14) inside a yet-to-define learning objective to thus learn codebooks, and (ii) use the exact one-hot-coded vector \hat{b}(x,C) (or rather, its equivalent representation q(x,C)) to encode the database [symbol] ={xᵢ}ᵢ into quantization indices {jᵢ=q(xᵢ,C)}. In this way, we benefit from the differentiability of b^{α}(x,C) at learning time, while retaining the compacity and functionality of the representation q(x,C) when storing the database.

For ease of exposition, in the following we will let b denote either of Eq. (14) or (17), and write the corresponding expression for Eq. (15) as

Q(x;C)=Cb(x;C). (18)

Synthesis Codebooks

We note that in the ANN task we are not interested in getting good approximations of a vector x, but rather good approximations of the set [symbol] of nearest neighbors. Hence we will consider the following generalization of Eq. (18):

Q(x;B,C)=Bb(x;C) (19)

In this case, the codebook C can be seen as an analysis codebook, as it transforms the vector x into a new representation. The codebook used to obtain a lossy reconstruction (i.e., to synthesize) of x from this new representation is B, and hence we refer to it as the synthesis codebook.

According to Eq. (19), a codebook C is used to obtain the index of a codevector to represent x (j=q(x,C)) and form the vector b(x; C), then another codebook B is used to get the approximation of vector x based on the index j. This method differentiates itself from others in that it uses different codebooks at quantization and approximation. The codebook B can have a same or different number of codevectors as C. Having such a codebook gives us extra flexibility to adapt the encoding process to the ANN task, and it generalizes the standard VQ approach wherein B=C.

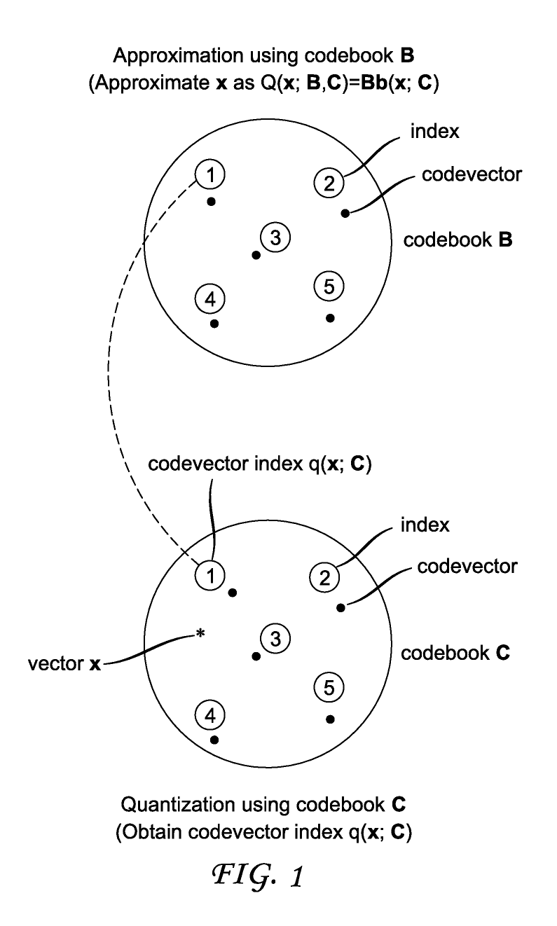

FIG. 1 illustrates using two different codebooks for quantization and approximation using a simplified example, according to an embodiment of the present principles. In this example, there are five codevectors for codebook B or C, and codebook B is different from codebook C. Using codebook C, vector x is closest to code vector 1 and is quantized as codevector 1 in codebook C (i.e., q(x,C)=1), as shown at the bottom of FIG. 1. Using the codevector index obtained from codebook C, codevector 1 of codebook B is used to approximate vector x.

Using different codebooks for quantization and approximation gives the model greater flexibility. When codebook B is constrained to be equal to codebook C, the obtained codebook C will be the same as using one codebook. When the size of codevectors in B is smaller than that of C, the method would also provide regularization, and the performance on a test set (disjoint of the training set) could potentially be better. A smaller B would also reduce complexity, since the construction of the lookup tables would be done in a space of a lower dimension.

For consistency with the latter discussions involving PQ and RQ, we let

R^{VQ}(x;B,C)=Q(x;B,C) (20)

denote the resulting approximation of x for the case of VQ.

Extension to Product Quantization

The differentiable representations of VQ as well as synthesis codebooks can be applied to product quantization. We note that PQ produces an approximation of a signal vector x given by

[cⱼ_{₁}^{1T}, . . . ,cⱼ_{_{P}}^{PT}]^{T}, (21)

where jₗ=q(x^{l},Cₗ), and c denotes codevector j of codebook Cₚ. The PQ follows by substituting Q(x^{l}; Bₗ,Cₗ) in place of cⱼ_{ₗ}^{l}. Accordingly, letting [symbol] ={B₁, . . . , B_{P}} and [symbol] ={C₁, . . . , C_{P}}, the resulting reconstruction of a given vector x can be written as

R^{PQ}(x; [symbol] , [symbol] )=[Q(x¹;B₁,C₁)^{T}, . . . ,Q(x^{P};B_{P},C_{P})^{T}]^{T}. (22)

Extension to Residual Quantization

A similar approach can be used to obtain a differentiable representation of VQ that further employs synthesis codebooks. Letting [symbol] ={B₁, . . . , B_{P}} denote the synthesis codebooks, we re-write the residual computation expression in Eq. (11) as follows:

r^{l}=r^{l-1}−Q(r^{l};Bₗ,Cₗ). (23)

Let us denote [symbol] ={C₁, . . . , C_{P}}, the reconstruction of x=r⁰,

R^{RQ}(x; [symbol] )=Σₗ₌₁^{P}Q(r^{l};Bₗ,Cₗ) (24)

can be obtained by concatenating many such layers. Hence residual quantization can be interpreted as a deep network with non-linearities of the form b(·,·) in Eq. (14) or (17).

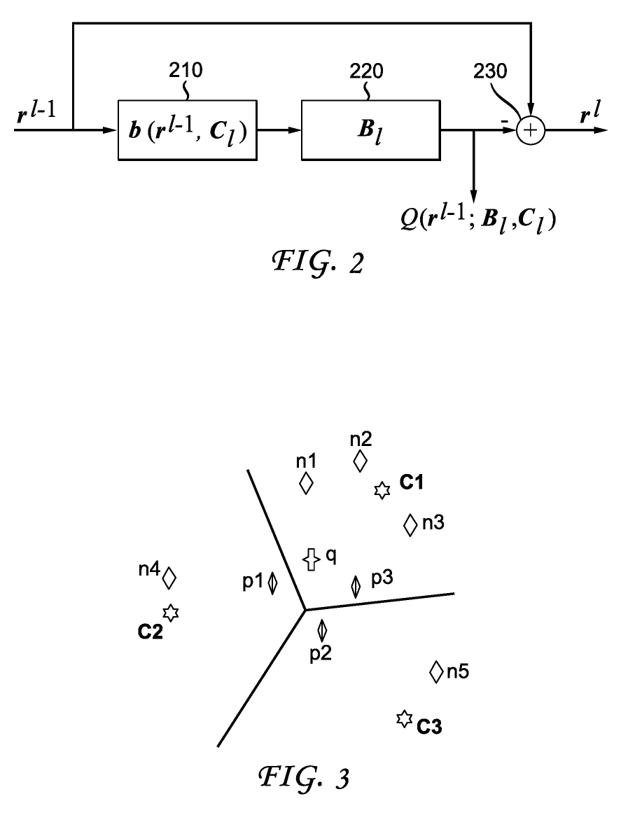

FIG. 2 shows that residual quantization can be interpreted as a deep network, according to an embodiment of the present principles. At l-th layer, residual r^{l-1} is quantized into b(r^{l-1},Cₗ) at step 210, and then approximated using codebook Bₗ as Q(r^{l-1},Bₗ,Cₗ). At step 230, the difference between r^{l-1} and Q(r^{l-1},Cₗ) is used to produce the new residual r^{l} that is fed to the next layer.

Learning Codebooks

Using the Jacobians of the one-hot encoding vector b, we now formulate a learning objective that will allow us to learn codebooks by means of gradient descent methods. In one embodiment, we assume that we are given a set of training vectors [symbol] ={xⱼ}ⱼ along with a set of annotations [symbol] consisting of triples (k, k₊, k₋) so that, for an arbitrary reference vector xₖ∈ [symbol] , vectors xₖ_{₊}∈ [symbol] and xₖ_{_}∈ [symbol] are, respectively, a matching and a non-matching vector of xₖ. In the context of ANN search where [symbol] is the set of nearest neighbors of xₖ, we choose our triplets so that

k₊∈ [symbol] (xₖ),k₋∉ [symbol] (xₖ). (25)

One can think of a given reference vector xₖ as simulating a query vector, with xₖ_{₊} and xₖ_{_{−}} being database vectors that are correct and incorrect matches, respectively. Accordingly, we encode xₖ_{₊} and xₖ_{_{−}} using one of the above described methods to obtain R(xₖ₊; [symbol] , [symbol] ) and R(xₖ₋; [symbol] , [symbol] ), where R can denote one of Eq. (20) (letting [symbol] ={B} and [symbol] ={C}), (22) or (24).

FIG. 3 illustrates an exemplary training set, wherein q is a training query vector, C1, C2, and C3 are codevectors, p1, p2, and p3 are k-nearest neighbors, based on exact distance (k=3), and n1, n2, . . . n5 are negative examples for q. Here the training vectors are obtained from the training images through feature extraction. Overall, the training set includes triplets: (q,p1,n1), (q,p1,n2), (q,p1,n5), (q,p2,n1), . . . (q,p2,n5), (q,p3,n1), . . . (q,p3,n5).

Given this training set, we can now formulate our learning problem, which consists of learning sets of dictionaries [symbol] ={Cₗ}ₗ and [symbol] ={Bₗ}ₗ:

$${argmin}_{ℬ , 𝒞} \frac{1}{N} {\sum }_{j = 1}^{N} 𝓁 ( {x}_{{k}_{j}} , R ( {x}_{{k}_{+ j}} ; ℬ , 𝒞 ) , R ( {x}_{{k}_{- j}} ; ℬ , 𝒞 ) ) + {λ}_{1} ψ ( ℬ ) + {λ}_{2 ρ} ( 𝒞 ) . \qquad ( 26 )$$

The above expression is a standard regularized risk minimization problem. An adequate loss function [symbol] (x,y,z) should penalize triplets for which d(x,y)>d(x,z), e.g., [symbol] d(x,y)>d(x,z) [symbol] . In practice, given that this idealized loss has a zero derivative at all points where it is defined, an upper bound is instead used. Inspired from margin-maximization methods, we can use the following loss function

[symbol]

(x,y,z)=max(0,a−(d(x,z)−d(x,y)))≥ [symbol] d(x,y)>d(x,z) [symbol] a>0. (27)

Other loss functions can also be used, for example [symbol] (x,y,z)=max (0,a d(x,z)−d(x,y)), and

$$𝓁 ( x , y , z ) = max ( 0 , \frac{ad ( x , z ) - d ( x , y )}{( bd ( x , z ) + cd ( x , y ) )} ) ,$$

where the first loss function has the advantage that the difference is not compared to a fixed value as in Eq. (27), and the second loss function has the further advantage that the difference is normalized by the mean distance and hence all triplets contribute in a more balanced way to the optimization cost. The values of a, b and c in all the above loss functions need to be set empirically by means of cross-validation. In doing so, these scalars can be constrained, for example to the interval (0,1] and also so that b+c=1.

The regularizers ψ and ρ are used to restrict the hypothesis class from which the models [symbol] and [symbol] are chosen, thus preventing overfitting. A common regularizer can be derived from the Frobenius norm. Letting [symbol] ={Aₗ}ₗ denote [symbol] or [symbol] ,

$$ψ ( 𝒜 ) = ρ ( 𝒜 ) = {\sum }_{l} {‖ {A}_{l} ‖}_{F}^{2} , \qquad ( 28 )$$

where ∥·∥_{F}² is the Frobenius norm, although other regularizers are possible.

Solution Using Stochastic Gradient Descent (SGD)

We will use Stochastic Gradient Descent to solve Eq. (26), as it has been proven to yield better generalization performance with less training complexity relative to other methods when learning over large training sets. SGD has further been shown empirically to be good at addressing non-smooth objectives, and we can expect the objective in Eq. (26) to be non-smooth when using Eq. (14).

SGD is applicable to objectives that have the form Σⱼϕ(θ,τⱼ), and this is the case for the objective in Eq. (26) if we let θ=( [symbol] , [symbol] ), τⱼ=(xₖ_{ⱼ},xₖ_{₊ⱼ}, xₖ_{_{−j}}) and

ϕ(θ,Tⱼ)= [symbol] (xₖ_{ⱼ},R(xₖ_{₊ⱼ}; [symbol] , [symbol] ),R(xₖ_{_{−j}}; [symbol] , [symbol] ))+λ₁ψ( [symbol] )+λ₂ρ( [symbol] ). (29)

With this, SGD proceeds iteratively by randomly picking, at iteration t, triplet jₜ from training set [symbol] ={τⱼ}ⱼ and updating the current estimate θ^{(t-1)} of θ using

θ^{t}=θ^{t-1}−γₜ∇_{θ}ϕ(θ,τⱼ_{ₜ})|_{θ}_{^{(t-1)}}. (30)

The scalar γₜ is known as the learning rate, and can be set empirically to be a sufficiently small constant or a decaying sequence.

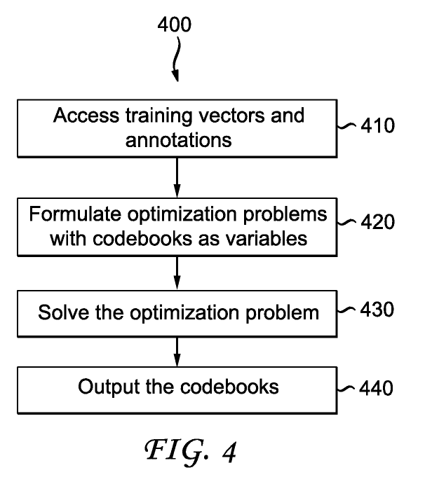

FIG. 4 illustrates an exemplary method 400 for training the codebooks, according to an embodiment of the present principles. At step 410, method 400 obtains training vectors [symbol] ={xⱼ}ⱼ along with a set of annotations [symbol] consisting of triplets (k,k₊,k₋), wherein for a reference vector xₖ∈ [symbol] , vectors xₖ_{₊}∈ [symbol] is a matching vector of xₖ, and xₖ_{_{−}}∈ [symbol] is a non-matching vector of xₖ. At step 420, the learning problem is formulated, with learning sets of dictionaries [symbol] ={Cₗ}ₗ and [symbol] ={Bₗ}ₗ as variables, for example, as described in Eq. (26). At step 430, the minimization problem is solved, for example, using stochastic gradient descent (SGD), based on Eqs. (29)-(30). At step 440, the trained codebooks B and [symbol] are output as the solution. The trained codebooks may be stored in a memory or any other storage device.

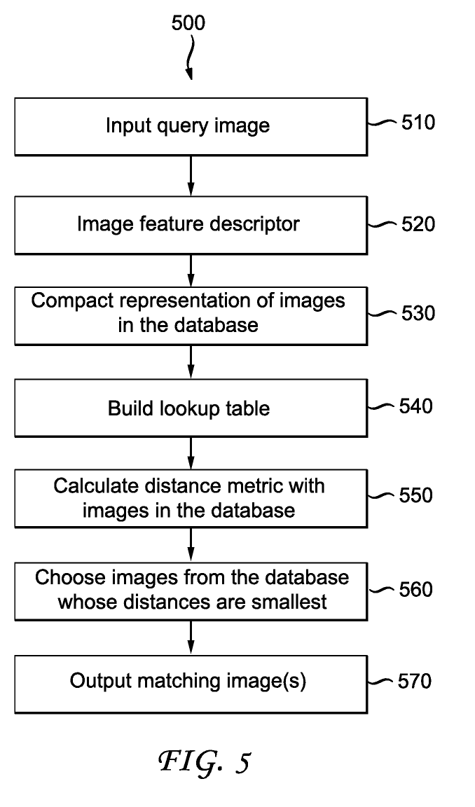

FIG. 5 illustrates an exemplary method 500 for performing image search, according to an embodiment of the present principles. At step 510, a query image is input. Subsequently, a feature vector y is obtained for the query image at step 520. A feature vector of an image contains information describing an image's important characteristics. Common image feature construction approaches usually first densely extract local descriptors such as SIFT (Scale-invariant feature transform) from multiple resolutions of the input image and then aggregate these descriptors into a single vector y. Common aggregation techniques include methods based on K-means models of the local descriptor distribution, such as bag-of-words and VLAD (Vector of Locally Aggregated Descriptors) encoding, and Fisher encoding, which is based on a GMM (Gaussian Mixture Model) model of the local descriptor distribution.

At step 530, feature vectors S={xᵢ}ᵢ of images in a database are encoded to obtain compact representation, for example, using Eq. (8) or Eq. (11). In an exemplary embodiment where product quantization is used, each l-th sub-vector xᵢ^{l} of each database image feature vector xᵢ is encoded, to obtain a sequence of ordered codevector indices, j₁, . . . , j_{P}, where P is the number of sub-vectors xᵢ^{l} and accordingly also the number of codebooks used.

At step 540, P lookup tables are built, one for each sub-vector yₗ of the query L(yₗ,Bₗ), l=1, . . . , P. When regular vector quantization is used, P=1. For PQ, typical values of P are in the range 2 to 16, and this value can be selected empirically. For each vector xᵢ, we may choose an index jᵢ based on codebook [symbol] , jᵢ=q(xᵢ,C), and then represent xᵢ using codebook [symbol] , as jᵢ-th codevector in [symbol] , kⱼ_{ᵢ}. Subsequently, rather than computing the exact distance between a query vector y and xᵢ, we may tabulate the difference between y and bⱼ, and obtain the difference between y and bⱼ_{ᵢ} from the lookup table.

At step 550, based on the codevector indices obtained at step 530 and the lookup table generated at step 550, a distance measure between the query image and each database image can be calculated. At step 560, the images whose distances are smallest are chosen, for example, based on τₚ₌₁^{P}(μⱼ_{ₚ}^{p}(y^{P})), where j₁, . . . , j_{P} are the quantization indices for the database image being compared to and obtained, for example, via Eq. (8) from the database, where μⱼ_{ₚ}^{p}(y^{P}) is entry jₚ of the p-th lookup table. The choice may also depend on the number of matches needed. At step 570, those chosen images are output as matching images.

The order of steps for method 500 can be different from what is shown in FIG. 5. For example, steps 510 and 520 can be performed before steps 530 and 540. Both pairs of steps can be performed in parallel. Steps 530 and 540 may only need to be performed once for all queries y, as opposed to doing it for every query, which would be more expensive than exhaustive search.

In the above, we mention that the codebooks B and C in Eq. (19) have the same number of codevectors, but the codevectors need not be of the same size. To apply this more generalized version where the number of rows in B and C are not same, we need following alteration while computing the approximate distance of a given query y to a database vector x. We apply a transformation matrix M on the query vector, i.e.,

|My−Bb(x;C)∥₂². (31)

This is the case when we are interested in asymmetric distance that is the query vector is not quantized. While for the symmetric distance computation, where the query is also quantized,

∥Bb(y;C)−Bb(x;C)∥₂², (32)

there is no modification required.

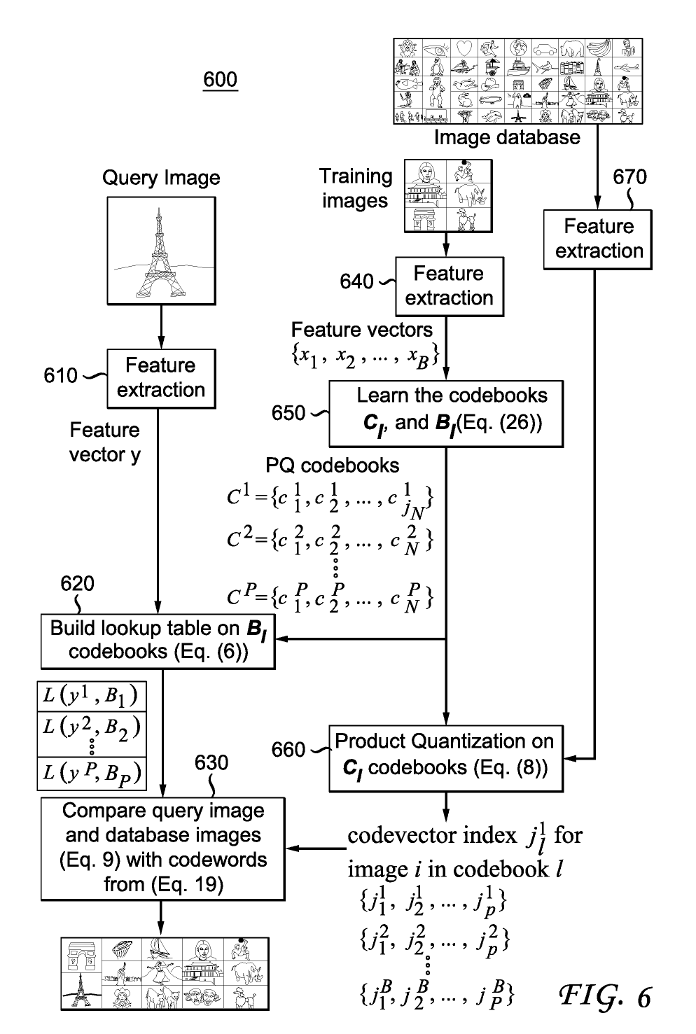

FIG. 6 illustrates an exemplary framework 600 for performing image search, according to an embodiment of the present principles.

For the training image database, feature vectors are extracted (640) for the images as x₁, x₂, . . . , x_{B}, respectively. The sets of codebooks [symbol] ={B₁, . . . B_{P}} and C={C₁, . . . , C_{P}} can then be trained (650), for example, as a minimization problem defined in Eq. (26).

For a query image, feature vector y is extracted at 610. Based on feature vector y, a set of lookup tables, L(y^{l},Bₗ), l=1, . . . ,P, can be generated (620) using codebooks [symbol] ={B₁, . . . B_{P}}, one for each sub-vector yₗ of the query. The feature vectors are also extracted for the database images (670). Based on codebooks C={C₁, . . . , C_{P}}, an image i in a database where image search is performed can be quantized (660) as {j₁ⁱ, j₂ⁱ, . . . , j_{P}ⁱ}, i=1, . . . , B, for example, using Eq. (8).

Then using the codevector index jₗⁱ to index lookup table L(y^{l},Bₗ), the distance between the query image and database image i can be retrieved from the lookup tables (630). Note that for ease of notations, we assume the training image database and the image search database have the same number of images. In other embodiments, these two databases can have different numbers of images.

Based on the distances, several images are output as search results. In one embodiment, the database images are sorted in increasing order of the approximate distance to the query, and the N highest ranked images are output as search results.

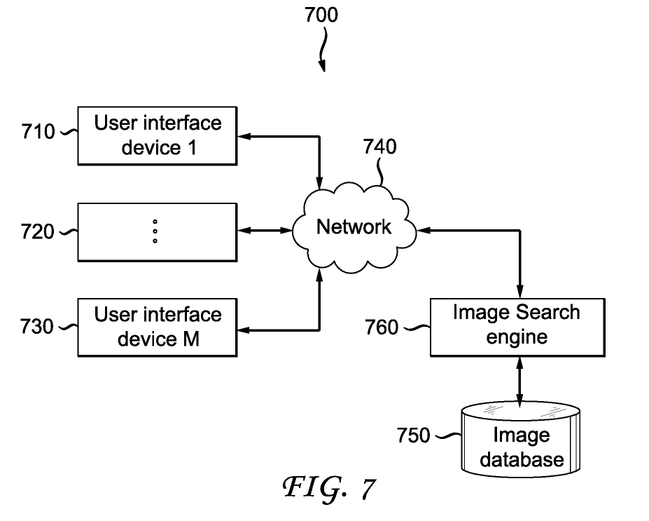

FIG. 7 illustrates an exemplary system 700 that has multiple user devices connected to an image search engine according to the present principles. In FIG. 7, one or more user devices (710, 720, and 730) can communicate with image search engine 760 through network 740. The image search engine is connected to multiple users, and each user may communicate with the image search engine through multiple user devices. The user interface devices may be remote controls, smart phones, personal digital assistants, display devices, computers, tablets, computer terminals, digital video recorders, or any other wired or wireless devices that can provide a user interface.

The image search engine 760 may implement various methods as discussed above. Image database 750 contains one or more databases that can be used as a data source for searching images that match a query image or for training the parameters.

In one embodiment, a user device may request, through network 740, a search to be performed by image search engine 760 based on a query image. Upon receiving the request, the image search engine 760 returns one or more matching images and/or their rankings. After the search result is generated, the image database 750 provides the matched image(s) to the requesting user device or another user device (for example, a display device).

When a user device sends a search request to the image search engine, the user device may send the query image directly to the image search engine. Alternatively, the user device may process the query image and send a signal representative of the query image. For example, the user device may perform feature extraction on the query image and send the feature vector to the search engine. Or the user device may further perform vector quantization and send the compact representation of the query image to the image search engine. These various embodiments distribute the computations needed for image search between the user device and image search engine in different manners. The embodiment to use may be decided by the user device's computational resources, network capacity, and image search engine computational resources.

The image search may also be implemented in a user device itself. For example, a user may decide to use a family photo as a query image, and to search other photos in his smartphone with the same family members.

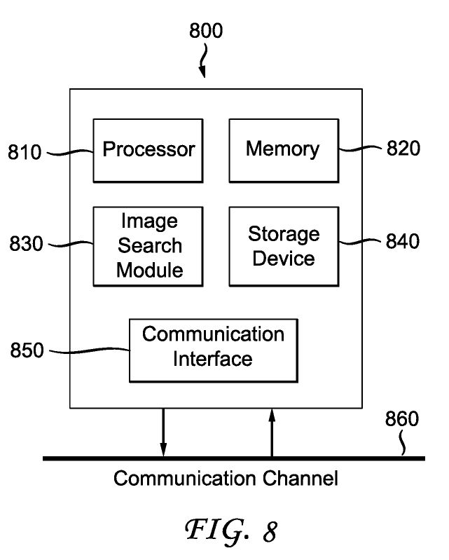

FIG. 8 illustrates a block diagram of an exemplary system 800 in which various aspects of the exemplary embodiments of the present principles may be implemented. System 800 may be embodied as a device including the various components described below and is configured to perform the processes described above. Examples of such devices, include, but are not limited to, personal computers, laptop computers, smartphones, tablet computers, digital multimedia set top boxes, digital television receivers, personal video recording systems, connected home appliances, and servers. System 800 may be communicatively coupled to other similar systems, and to a display via a communication channel as shown in FIG. 8 and as known by those skilled in the art to implement the exemplary video system described above.

The system 800 may include at least one processor 810 configured to execute instructions loaded therein for implementing the various processes as discussed above. Processor 810 may include embedded memory, input output interface and various other circuitries as known in the art. The system 800 may also include at least one memory 820 (e.g., a volatile memory device, a non-volatile memory device). System 800 may additionally include a storage device 840, which may include non-volatile memory, including, but not limited to, EEPROM, ROM, PROM, RAM, DRAM, SRAM, flash, magnetic disk drive, and/or optical disk drive. The storage device 840 may comprise an internal storage device, an attached storage device and/or a network accessible storage device, as non-limiting examples. System 800 may also include an image search engine 830 configured to process data to provide image matching and ranking results.

Image search engine 830 represents the module(s) that may be included in a device to perform the image search functions. Image search engine 830 may be implemented as a separate element of system 800 or may be incorporated within processors 810 as a combination of hardware and software as known to those skilled in the art.

Program code to be loaded onto processors 810 to perform the various processes described hereinabove may be stored in storage device 840 and subsequently loaded onto memory 820 for execution by processors 810. In accordance with the exemplary embodiments of the present principles, one or more of the processor(s) 810, memory 820, storage device 840 and image search engine 830 may store one or more of the various items during the performance of the processes discussed herein above, including, but not limited to a query image, the codebooks, compact representation, lookup tables, equations, formula, matrices, variables, operations, and operational logic.

The system 800 may also include communication interface 850 that enables communication with other devices via communication channel 860. The communication interface 850 may include, but is not limited to a transceiver configured to transmit and receive data from communication channel 860. The communication interface may include, but is not limited to, a modem or network card and the communication channel may be implemented within a wired and/or wireless medium. The various components of system 800 may be connected or communicatively coupled together using various suitable connections, including, but not limited to internal buses, wires, and printed circuit boards.

The exemplary embodiments according to the present principles may be carried out by computer software implemented by the processor 810 or by hardware, or by a combination of hardware and software. As a non-limiting example, the exemplary embodiments according to the present principles may be implemented by one or more integrated circuits. The memory 820 may be of any type appropriate to the technical environment and may be implemented using any appropriate data storage technology, such as optical memory devices, magnetic memory devices, semiconductor-based memory devices, fixed memory and removable memory, as non-limiting examples. The processor 810 may be of any type appropriate to the technical environment, and may encompass one or more of microprocessors, general purpose computers, special purpose computers and processors based on a multi-core architecture, as non-limiting examples.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for performing image search, comprising:
accessing a first feature vector corresponding to a query image;
encoding a second feature vector, corresponding to a second image of an image database, as an encoded vector using a first set of codebooks and a second set of codebooks, the first set of codebooks being different from the second set of codebooks,
wherein the first set of codebooks is used to vector quantize the second feature vector into an index, and wherein the second feature vector is approximated as the encoded vector corresponding to the index in the second set of codebooks;
determining a distance measure between the query image and the second image, based on the first feature vector and the encoded vector; and
providing, responsive to the distance measure between the query image and the second image, the second image as output.

2. The method according to claim 1, wherein at least one of the query image and the first feature vector is received from a user device via a communication network, the method further comprising transmitting a signal indicating the second image to the user device via the communication network.

3. The method of claim 1, wherein the first set of codebooks and the second codebooks are determined based on a set of triplet constraints, wherein each triplet constraint indicates that a first training image of the triplet is more similar to a second training image of the triplet than to a third training image of the triplet.

4. The method of claim 3, wherein the first set of codebooks and the second codebooks are trained such that a distance measure determined for training images corresponding to a triplet constraint is consistent with what the triplet constraint indicates.

5. The method of claim 1, wherein the distance measure is determined based on one or more lookup tables.

6. The method of claim 1, wherein one of vector quantization, product quantization and residual quantization is used to vector quantize the second feature vector.

7. The method of claim 1, wherein
the second set of codebooks is smaller than the first set of codebooks.

8. The method of claim 7, wherein the first feature vector is transformed, and the distance measure is determined based on the transformed first feature vector and the encoded vector.

9. An apparatus for performing image search, comprising:
an input configured to access at least one of a query image and a first feature vector corresponding to the query image; and
one or more processors configured to:
encode a second feature vector corresponding to a second image of an image database, as an encoded vector using a first set of codebooks and a second set of codebooks, the first set of codebooks being different from the second set of codebooks,
wherein the first set of codebooks is used to vector quantize the second feature vector into an index, and wherein the second feature vector is approximated as the encoded vector corresponding to the index in the second set of codebooks,
determine a distance measure between the query image and the second image, based on the first feature vector and the encoded vector, and
provide, responsive to the distance measure between the query image and the second image, the second image as output.

10. The apparatus of claim 9, wherein the first set of codebooks and the second codebooks are determined based on a set of triplet constraints, wherein each triplet constraint indicates that a first training image of the triplet is more similar to a second training image of the triplet than to a third training image of the triplet.

11. The apparatus of claim 10, wherein the first set of codebooks and the second codebooks are trained such that a distance measure determined for training images corresponding to a triplet constraint is consistent with what the triplet constraint indicates.

12. The apparatus of claim 9, wherein the distance measure is determined based on one or more lookup tables.

13. The apparatus of claim 9, wherein one of vector quantization, product quantization and residual quantization is used to vector quantize the second feature vector.

14. The apparatus of claim 9, wherein the second set of codebooks is smaller than the first set of codebooks.

15. A non-transitory computer readable storage medium having stored thereon instructions for implementing a method for performing image search, the method comprising:
accessing a first feature vector corresponding to a query image;
encoding a second feature vector, corresponding to a second image of an image database, as an encoded vector using a first set of codebooks and a second set of codebooks, the first set of codebooks being different from the second set of codebooks,
wherein the first set of codebooks is used to vector quantize the second feature vector into an index, and wherein the second feature vector is approximated as the encoded vector corresponding to the index in the second set of codebooks;
determining a distance measure between the query image and the second image, based on the first feature vector and the encoded vector; and
providing, responsive to the distance measure between the query image and the second image, the second image as output.

16. The medium of claim 15, wherein the first set of codebooks and the second codebooks are determined based on a set of triplet constraints, wherein each triplet constraint indicates that a first training image of the triplet is more similar to a second training image of the triplet than to a third training image of the triplet.

17. The medium of claim 15, wherein the distance measure is determined based on one or more lookup tables.

18. The medium of claim 15, wherein one of vector quantization, product quantization and residual quantization is used to vector quantize the second feature vector.

19. The medium of claim 15, wherein the second set of codebooks is smaller than the first set of codebooks.

20. The method of claim 19, wherein the first feature vector is transformed, and the distance measure is determined based on the transformed first feature vector and the encoded vector.
